(19) United States
(12) Patent Application Publication
(10) Pub. No.: US 2011/0170427 A1
(43) Pub. Date: Jul. 14, 2011

(54) Best Companion PMI-Based Beamforming

(75) Inventors: Tommi T. Koivisto, Espoo (FI); Mihai Enescu, Espoo (FI); Timo E. Roman, Espoo (FI); Timo E. Lunttila, Espoo (FI); Karol Schober, Helsinki (FI)

(73) Assignee: Nokia Corporation

(21) Appl. No.: 12/685,103

(22) Filed: Jan. 11, 2010

(51) Int. Cl. H04L 12/26

(52) U.S. Cl. 370/252

(57) ABSTRACT

From one perspective, a fixed rank r (r>1 is an integer) is determined from received signaling; at least one codeword of rank r is selected from a codebook of antenna weights for controlling inter-cell interference between a serving cell and a neighboring cell; and the selected at least one codeword of rank-r is reported to the serving cell. From a different perspective, the fixed rank r is derived and signaled to user equipments UEs operating in a serving cell; there is received from a UE in the serving cell a report indicating the at least one rank-r codeword; and an indication of the at least one rank-r codeword is forwarded to the neighboring cell. Methods, apparatus and computer programs are detailed as well as embodiments in which different ranks are used for different neighboring cells and narrowband/wideband PMI reporting which can also be different for different neighboring cells.

### TECHNICAL FIELD

The exemplary and non-limiting embodiments of this invention relate generally to wireless communication systems, methods, devices and computer programs and, more specifically, relate to cooperative beamforming among neighboring cells.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

CoMP cooperative multipoint

CQI channel quality information

CRS common reference signal

CSI channel state information

CSI-RS channel state information—reference signal

eNB EUTRAN Node B (evolved Node B/base station)

EPC evolved packet core

E-UTRAN evolved UTRAN (LTE)

IMT international mobile telecommunications

ITU-R international telecommunication union—radio

LTE long term evolution

MM/MME mobility management/mobility management entity

MIMO multiple input multiple output

PMI precoding matrix index

RI rank indicator

RRC radio resource control

SC-FDMA single carrier, frequency division multiple access

SU single user

TRI transmission rank indicator

UE user equipment

UTRAN universal terrestrial radio access network

In the communication system known as evolved UTRAN (E-UTRAN, also referred to as UTRAN-LTE, E-UTRA or 3.9G), the LTE Release 8 is completed, the LTE Release 9 is being standardized, and the LTE Release 10 is currently under development within the 3GPP. In LTE the downlink access technique is OFDMA, and the uplink access technique is SC-FDMA, and these access techniques are expected to continue in LTE Release 10.

FIG. 1 reproduces FIG. 4.1 of 3GPP TS 36.300, V8.6.0 (2008-09), and shows the overall architecture of the E-UTRAN system. The EUTRAN system includes eNBs, providing the EUTRA user plane and control plane (RRC) protocol terminations towards the UE. The eNBs are interconnected with each other by means of an X2 interface. The eNBs are also connected by means of an S1 interface to an EPC, more specifically to a MME and to a Serving Gateway. The S1 interface supports a many to many relationship between MMEs/Serving Gateways and the eNBs.

Of particular interest herein are the further releases of 3GPP LTE targeted towards future IMT-Advanced systems, referred to herein for convenience simply as LTE-Advanced (LTE-A). LTE-A is directed toward extending and optimizing the 3GPP LTE Release 8 radio access technologies to provide higher data rates at very low cost. LTE-A will most likely be part of LTE Release 10. LTE-A is expected to use a mix of local area and wide area optimization techniques to fulfill the ITU-R requirements for IMT-Advanced while keeping the backward compatibility with LTE Release 8 and Release 9.

Topics that are included within ongoing study items to this end include bandwidth extensions beyond 20 MHz, relays, cooperative MIMO, and other MIMO enhancements including enhancements to multi-user MIMO. One specific cooperative MIMO scheme (COMP) is coordinated beamforming in which the transmit precoders (for example, antenna weights) used for transmission in neighboring cells are coordinated so as to cause minimum interference to the ongoing transmissions in other cells.

Two general approaches are known for UEs reporting PMI (which indicate the transmit precoders/antenna weights) for coordinating beamforming in neighbor cells: the UE reporting its best PMI (least interfering), and the UE reporting its worst PMI (most interfering). See for example the following documents:
R1-093780, entitled “Estimation of extended PMI feedback signaling required for user intra-cell and inter-cell coordination”, by Alcatel-Lucent and Alcatel-Lucent Shanghai Bell (3GPP TSG RAN WG1 #58bis Meeting, Miyazaki Japan, 12-16 Oct. 2009); and
R1-09-3781, entitled “Consideration of performance of coordinated beamforming with PMI feedback”, also by Alcatel-Lucent and Alcatel-Lucent Shanghai Bell (3GPP TSG RAN WG1 #58bis Meeting, Miyazaki Japan, 12-16 Oct. 2009).

When reporting channel space of rank larger than one, typical SU-MIMO feedback reports the optimum transmission rank as well as the corresponding signal space using PMI. Since LTE-A is to be backward compatible the most obvious relevant teaching appears to be LTE Release 8, in which the UE reports rank indicator (RI) that implies the dimension of the PMI that is reported along with the RI. This is described in section 7.2 of 3GPP TR 36.213, V8.8.0 (2009-09), 3rd Generation Partnership Project; Technical Specification Group Radio Access Network; Evolved Universal Terrestrial Radio Access (E-UTRA); Physical layer procedures (Release 8). But this teaches against having a fixed rank since the sustainable transmission rank completely depends on the eigenvalues of the underlying radio channel, and so a fixed rank (other than one) would not allow sustaining a transmission across the whole SINR range. The codebook subset restriction specified in LTE Release 8 could be used to restrict the UE to report always PMI corresponding to a certain rank, but this makes it not possible to report simultaneously any other (lower) rank.

### SUMMARY

The foregoing and other problems are overcome, and other advantages are realized, by the use of the exemplary embodiments of this invention.

In a first aspect thereof the exemplary embodiments of this invention provide a method, comprising: determining from received signaling a fixed rank r, in which r is an integer greater than one; estimating from a codebook of antenna weights at least one codeword of rank r for controlling inter-cell interference between a serving cell and a neighboring cell; and reporting the selected at least one codeword of rank-r to a serving cell.

In a second aspect thereof the exemplary embodiments of this invention provide a memory storing a program of computer readable instructions that when executed by a processor result in actions comprising: determining from received signaling a fixed rank r, in which r is an integer greater than one; estimating from a codebook of antenna weights at least one codeword of rank r for controlling inter-cell interference between a serving cell and a neighboring cell; and reporting the selected at least one codeword rank-r to a serving cell.

In a third aspect thereof the exemplary embodiments of this invention provide an apparatus, comprising at least one processor and at least one memory including computer program code. The at least one memory and the computer program code are configured to, with the at least one processor, cause the apparatus to perform: determining from received signaling a fixed rank r, in which r is an integer greater than one; estimating from a codebook of antenna weights at least one codeword of rank r for controlling inter-cell interference between a serving cell and a neighboring cell; and reporting the selected at least one codeword of rank-r to a serving cell.

In a fourth aspect thereof the exemplary embodiments of this invention provide a method comprising: deriving a fixed rank r, in which r is an integer greater than one; signaling the rank r to user equipments operating in a serving cell; receiving from an individual one of the user equipments in the serving cell a report indicating at least one rank r codeword of a codebook of antenna weights for controlling inter-cell interference between the serving cell and a neighboring cell; and forwarding to the neighboring cell an indication of the at least one rank r codeword.

In a fifth aspect thereof the exemplary embodiments of this invention provide a memory storing a program of computer readable instructions that when executed by a processor result in actions comprising: deriving a fixed rank r, in which r is an integer greater than one; signaling the rank r to user equipments operating in a serving cell; receiving from an individual one of the user equipments in the serving cell a report indicating at least one rank r codewords of a codebook of antenna weights for controlling inter-cell interference between the serving cell and a neighboring cell; and forwarding to the neighboring cell an indication of the at least one rank r codeword.

In a sixth aspect thereof the exemplary embodiments of this invention provide an apparatus, comprising at least one processor and at least one memory including computer program code. The at least one memory and the computer program code are configured to, with the at least one processor, cause the apparatus to perform: deriving a fixed rank r, in which r is an integer greater than one; signaling the rank r to user equipments operating in a serving cell; receiving from an individual one of the user equipments in the serving cell a report indicating at least one rank r codeword of a codebook of antenna weights for controlling inter-cell interference between the serving cell and a neighboring cell; and forwarding to the neighboring cell an indication of the at least one rank r codeword.

These and other aspects of the invention are detailed more fully below.

### BRIEF DESCRIPTION OF THE DRAWINGS

FIG. 1 reproduces FIG. 4 of 3GPP TS 36.300, and shows the overall architecture of the E-UTRAN system.

FIG. 2A shows apparatus arranged in an exemplary cooperative beamforming transmission environment having a serving cell and two neighboring cells each with one mobile user, and further showing data exchanges according to an exemplary embodiment of the invention.

FIG. 3A shows a simplified block diagram of certain apparatus according to various exemplary embodiments of the invention.

FIG. 3B shows a more particularized block diagram of a user equipment such as that shown at FIG. 3A.

FIG. 4 is a logic flow diagram that illustrates the operation of a method, and a result of execution of computer program instructions embodied on a computer readable memory, in accordance with the exemplary embodiments of this invention from the perspective of the user equipment.

FIG. 5 is a logic flow diagram that illustrates the operation of a method, and a result of execution of computer program instructions embodied on a computer readable memory, in accordance with the exemplary embodiments of this invention from the perspective of the network access node.

### DETAILED DESCRIPTION

Consider the worst companion PMI index (WCI) reporting, in which the UE reports the PMI(s) that would cause most interference to it if applied in the neighboring cell(s) on the same time-frequency resources. Hence, the eNB taking care of scheduling for the neighboring cell(s) should try to avoid that PMI. The inventors have determined that avoiding the worst companion PMI is typically not sufficient—for example, the second worst PMI might in fact often turn out to be almost as bad in terms of causing interference to neighboring cells, or alternatively, especially in spatially uncorrelated channels, there might be other even completely orthogonal channel directions that still cause similar interference. So the worst companion PMI approach generally provides only very limited interference suppression gains, if any.

The best companion PMI reporting, in which the UE reports the PMI that causes least interference out of all possible PMIs when applied in the neighboring cell, gives much better interference suppression gains than the worst companion PMI approach. The best companion PMI approach allows each neighboring cell to use only the one PMI that is reported, and so is highly restrictive of the eNB's capacity to schedule transmissions by the UEs in its cell. The best companion PMI approach is most beneficial where losses due to the severe scheduling restrictions are outweighed by gains from interference suppression, such as for example in high load scenarios.

The two approaches each impose scheduling restrictions of course, since the neighbor eNB is restricted in which PMI it can choose. The worst companion PMI approach allows the neighbor eNB to use all other PMIs except the worst and so the scheduling restrictions it imposes are not as severe as the best companion PMI approach, which allows the neighbor eNB to use only the one reported best PMI.

From the above it is clear that the best and the worst PMI reporting approaches can be considered to impose a tradeoff between scheduling flexibility and interference suppression gains. Maximizing the interference suppression benefits while keeping additional scheduling restrictions to a minimum can benefit further standardization of LTE-A, and is a technical effect of exemplary embodiments of the invention.

According to an embodiment of the invention, rather than reporting a rank-1 best/worst companion PMI such as the techniques described in documents R1-093780 and R1-09-3781 cited above, the UE reports a channel subspace of higher dimension using rank-r PMI, with r being an integer greater than one. This corresponds to and describes (at least roughly) the null space of the interfering channel, i.e. the null space of the channel from a given neighboring cell to the UE. In this embodiment r is fixed, and may for example be semi-statically configured to the UE via higher layers. The UE can determine the fixed rank r via received signaling, such as by example an explicit indication received in broadcast system information or implicitly through reference signals the UE receives. Note that in this embodiment, the fixing of the rank r is done irrespective of the anticipated rank of the transmission in the neighboring cell. It is envisioned that the UE in the serving cell reports to that same serving cell information on interfering channels for one or more neighboring cells. The number of the neighboring cells on which the UE reports depends on how many of them are involved together in a coordinated beamforming transmission, and in an embodiment this information is semi-statically configured to the UE.

In a variation, there are different values for r for different neighboring cells, so for example r1 is the rank of the PMI(s) reported for a first neighboring cell, r2 is the rank of the PMI(s) reported for a second neighboring cell, and so forth, where r1 and r2 may be different values in one instance and the same value in another instance. The per-cell ranks r (as r1, r2, etc.) for the UE reporting null-space information is valuable for example where there are different antenna configurations among the different neighboring cells. Additionally, in one embodiment the PMI report which the UE sends to its serving cell corresponds to a narrowband PMI which reports on a number of physical resource blocks PRBs less than the total number of PRBs that make up the total bandwidth. In another embodiment the PMI report is wideband and corresponds to all PRBs in the bandwidth.

By example and not by way of limitation, the eNB may base its choice of the fixed rank r on the number of transmission antenna ports in the cell. The base station may then utilize any PMIs that cause the transmission to fall into the channel subspace defined by the rank-r PMI, hence minimizing interference to neighboring cells. One technique is to choose r as the number of transmit antenna ports divided by two and rounded up or down to the nearest integer. Typically the eigenvalues corresponding to half of the channel space dimension are already very low, especially if there is spatial correlation. Another technique for the eNB to choose the value for r could be based on a typical (for example, median or mean) number of receive antennas for UEs in the serving cell. By example, the eNB can determine this from capability information it receives on the individual UEs that it serves, and the typical number can reflect those UEs currently active in the serving cell or a historical average. If the number of transmit antennas in the neighboring cell is Nₜ and a typical number of UE receive antennas in the serving cell is Nᵣ, the null space dimension is always at least r=Nₜ−Nᵣ, hence using this value is also a viable technique for deriving the fixed value r.

Alternatively the rank r may be a) selected based on an expected spatial correlation that has an impact on the eigenvalues of the channel, or b) estimated from uplink using rank reciprocity of uplink and downlink channels, or c) based on a recommendation from the UE. An example of the latter is where the UE itself estimates the rank based on long-term channel statistics and semi-statically gives its recommendation to the eNB.

Above are several techniques for how the eNB can determine the value for the rank r of the null space to be reported by the UE to the eNB. Whether the eNB determines the value for the rank r as above or by some other technique, the eNB signals to the UE the chosen rank r for reporting null space information linked to the channels from the neighboring cells to the UE, or chosen ranks r1, r2, . . . rN, for reporting null space information linked to the channels from neighboring cell 1, cell 2, . . . , cell N, respectively, to the UE. More concisely, this can be expressed as m where n=1, 2, . . . N, where N is an integer number of neighboring cells for which the UE is configured to report. This signaling can be broadcast in the System Information, or it can be sent to the UE when the UE is configured via higher layers (for example via RRC signaling) to report feedback for the coordinated beamforming. That is, when the RRC signaling instructs the UE which neighbor cells it is to measure and report on for coordinated beamforming, that RRC signaling also carries the rank value r, and in the case where the value r is cell specific that RRC signaling carries the values per neighboring cell (for example, r1 for neighboring cell 1, r2 for neighboring cell 2, and so forth). As above, the value for r can also be determined by the UE via implicit signaling, such as for example the specific reference signal the serving or neighboring cell uses in its transmissions that the UE receives.

Having determined the value of r from that signaling which the UE received from the eNB or higher layers (which regardless is received from the serving cell), the UE then measures the channel from appropriate reference signals (for example, CRS or CSI-RS) for each neighboring cell that the UE is configured to report, and attempts precoding with each codeword or precoding vector/matrix (PMI) of the fixed rank r contained in the codebook of antenna weights. From those precoding attempts the UE then chooses the one PMI that minimizes the interference with that measured neighbor channel (such as for example the PMI which yields the lowest throughput or output/transmit power). Knowing this selected ‘best’ PMI for each neighboring cell which it is tasked to report on, the UE then reports that codeword (PMI) per neighboring cell to the serving cell/eNB, which thereafter distributes the PMIs among cooperating neighboring eNBs for use in their own scheduling decisions. In a specific embodiment for LTE-Advanced, the uplink channel used for this best-PMI reporting could be either the physical uplink control channel PUCCH or the physical uplink shared channel PUSCH. As noted above, in an embodiment there is a frequency selective PMI report that reports on less than the entire wideband PRBs. In this embodiment, the UE reports a best-r PMI per sub-band for each of the neighboring cells. This technique is seen to be valuable for spatially uncorrelated channels, where the benefit of frequency-specific PMI reporting outweighs the additional uplink signaling it involves. There is no limit that the UE must report the same sub-band for all the neighboring cells on which it reports; in a particular embodiment a UE is configured to report different frequency-specific PMIs (different RI) for different ones of its neighboring cells.

In addition to reporting the PMI, the UE can in some exemplary embodiments also report rank indication (RI) and/or channel quality information (CQI) for the serving cell as usual. The RI represents the preferred number of transmission layers maximizing the throughput of the given UE. Note that the eNB has the freedom of selecting the rank of the transmission (TRI) freely, regardless of the value of RI that the UE reports. To avoid confusion, below are summarized three different aspects of rank that is relevant to these teachings:
r=rank of the PMI report for interfering channels' null-space description.
RI=Rank Indicator, a recommendation for the number of spatial layers used for data transmission in the serving cell
TRI=rank of the data transmission, which the eNB selects (typically the same as RI).

The neighboring cell eNB(s) then choose the PMI(s) for scheduling, such that the used TRI, which is less than or equal to the rank-r PMI, falls into the space defined by the reported rank-r PMI. Following are some techniques which the neighboring eNB can use in various embodiments of the invention for choosing the PMI which minimizes the interference:
Choose exactly the reported PMI for transmission in case the rank of the transmission equals r. This corresponds to the normal best companion PMI scheme except that in this case r>1.
Use one or more columns of the reported PMI for transmission with TRI<r. This is especially useful with nested property codebooks, in which case the columns of the reported PMI correspond also to PMIs (of lower rank) found in the codebook. Therefore the eNB should easily be able to choose multiple possible TRI<r PMIs that are suitable for scheduling.
Find possible TRI<r PMIs whose projection onto the subspace defined by the reported rank-r PMI has low power. This approach will also yield multiple PM's that are eligible for scheduling, but just how many is dependent on the projection threshold (for example, how much power is allowed to leak out from the channel null space) and codebook design.

Clearly, any of the above techniques will give more than one PMI eligible for scheduling, which meets the technical effect of decreasing scheduling restrictions as compared to prior art best-PMI reporting approaches. Another technical effect of these exemplary embodiments is that this improvement to scheduling flexibility is accomplished with very low signaling impact, which typically is difficult in any multi-cell cooperative regimes.

It may be considered that embodiments of the invention provide solutions based on an implicit type of channel state information (CSI) feedback in the form of a transmit precoder indication (PMI). The solutions offered by these exemplary embodiments also extend to the case of other types CSI feedback, such as for example explicit CSI feedback or directional CSI feedback in the form of an eigenvector type of feedback. In a specific exemplary embodiment of the latter case, the UE reports one or more quantized eigenvector(s) corresponding to its signal space in its serving cell, while reporting up to r eigenvectors for the neighboring cells corresponding to the null-space of the interfering channels. Eigenvectors may be either quantized separately or jointly.

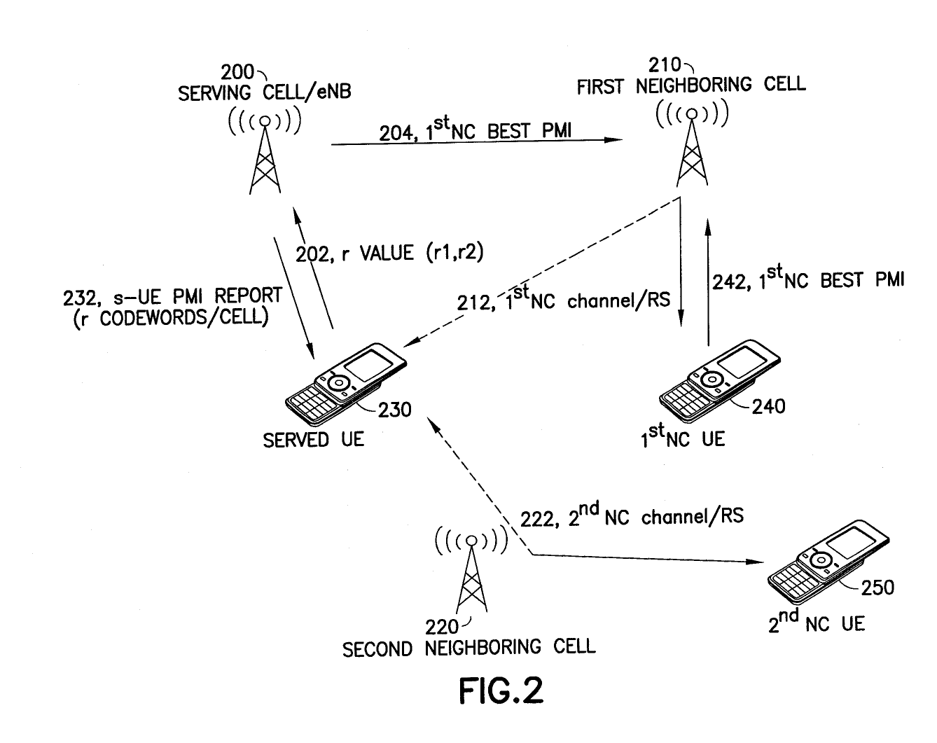

Consider the environment for embodiments of the invention as shown at FIG. 2. There is a first cell which is a serving cell 200 represented by a serving eNB, and there are also two neighboring cells distinguished as first neighboring cell embodied as a first neighboring eNB 210 and a second neighboring cell embodied as a second neighboring eNB 220. Each cell has typically multiple user equipments UEs under its control, but for simplicity FIG. 2 shows only one in each: a served UE 230 under control of the serving cell 210; a first neighboring cell NC UE 240 under control of the first neighboring cell 210, and a second neighboring cell NC UE 250 under control of the second neighboring cell 220.

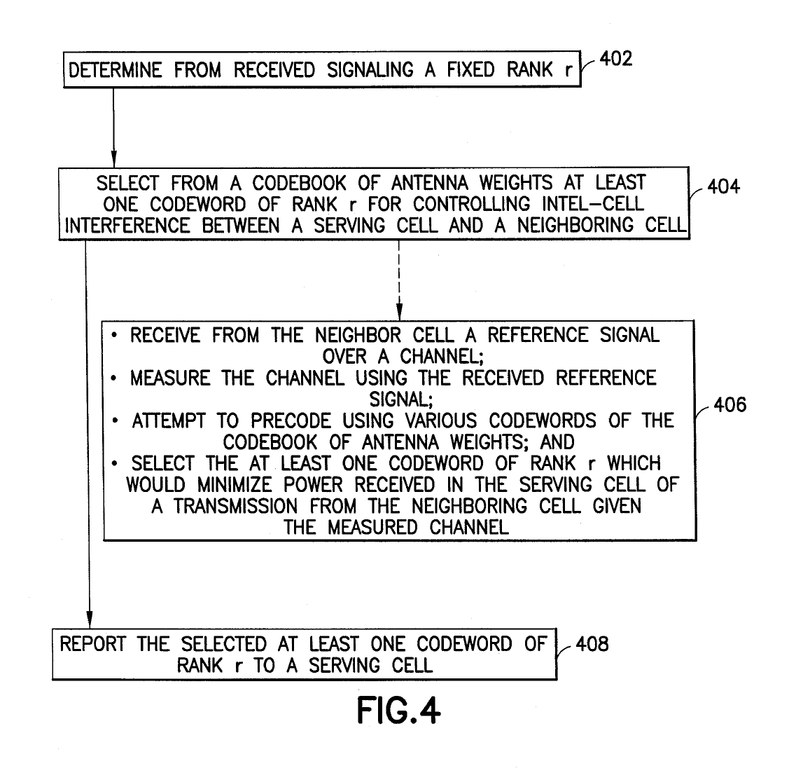

First consider an exemplary embodiment of the invention from the perspective of the served UE 230. First, the served UE 230 determines from received signaling a fixed rank r, in which r is an integer greater than one. This received signaling is shown as signaling 202 in which the serving eNB 200 sends to the served UE 230 the value for r. For the case where the serving cell 200 uses different ranks for the first and second neighboring cells 210, 220, that signaling 202 has r1 for the first neighboring cell 210 and r2 for the second neighboring cell 220, where r1 and r2 are not necessarily different but they may differ at the discretion of the serving eNB 200 which chooses the value r or r1 or r2. This is also shown at block 402 of FIG. 4. As noted above, this signaling 202 may be broadcast in system information, or sent via RRC signaling from higher layers in the serving cell or may be implicitly signaled to the served UE 230.

The served UE 230 receives a transmission from the first neighboring cell/eNB 210 on a first neighboring cell channel 212, and also receives a transmission from the second neighboring cell/eNB 220 on a second neighboring cell channel 222. Each of these transmissions has a reference signal (for example, a CRS or a CSI-RS), which the serving UE 230 uses to measure the respective channel 212, 222. The served UE 230 then attempts to precode a transmission (which it does not make) using various codewords of the codebook of antenna weights which it has stored locally in its memory. It is assumed that every node in FIG. 2 stores the identical codebook, so all that needs to be signaled is a PMI rather than a more involved bit sequence. From those precoding attempts, the served UE 230 selects at least one codeword of rank-r which would minimize or at least control inter-cell interference, specifically, it would minimize interference of a transmission, which is precoded with that PMI and directed by the neighboring cell 210 toward a neighboring UE 240 in that neighboring cell 210, with the UE 230 that selected the rank-r PMI. By example this minimized interference can be reflected as minimized receive power of a transmission from the neighboring cell 210 as received by the UE 230, given the measured channel 212 (assuming the neighboring cell 210 precoded its transmission with the selected codeword of rank-r that the UE 230 in the serving cell selected and reported). This is shown at block 404 of FIG. 4, with further detail of particular embodiments at block 406. The served UE 230 can estimate what would be the received energy from the neighboring cell for each of several rank-r codewords using the channel 212 from the neighboring cell 210 to the served UE 230 that the served UE 230 measures and estimates.

Note that a rank-r codeword is a codeword of r columns in the codebook of antenna weights. The UE 230 reports at least one of these rank-r codewords but in an embodiment can report more than one, such as for example in the narrowband PMI report in which the UE 230 reports a rank-r codeword for each of several frequency sub-bands. The UE 230 might also report more than one rank-r codeword for a common frequency (narrowband or wideband), reflecting for example best and next best codewords for minimizing inter-cell interference.

What is left from the perspective of the served UE 230 is simply reporting the rank-r codeword(s), which are for use in the neighboring cell 210, to the serving cell/eNB 200. This is shown at FIG. 2 by message 232 and at FIG. 4 by block 408. Note that where the served UE 230 reports multiple neighboring cells as FIG. 2 illustrates, the blocks of FIG. 4 will be repeated for each neighboring cell/eNB, either using a common value r or using a cell specific r1, r2, etc, as noted above. Therefore the served UE 230 reports the best rank-r PMI for each of the N neighboring cells it is configured to report on, and the value of the rank-r is given to the served UE 230 in message 202.

Not shown particularly at FIG. 2 but noted above, the served UE 230 can send to the serving cell/eNB 1200 a recommended value for r, prior to receiving the signaling 202 which gives it the fixed rank r which it will actually use for its report 232. In an exemplary embodiment particular to LTE and LTE-A, message 232 is sent on one of a physical uplink control channel PUCCH and a physical uplink shared channel PUSCH, and in various embodiments that message can also include one of a channel quality indication CQI and a rank indicator RI which indicates a number of spatial layers for data transmission.

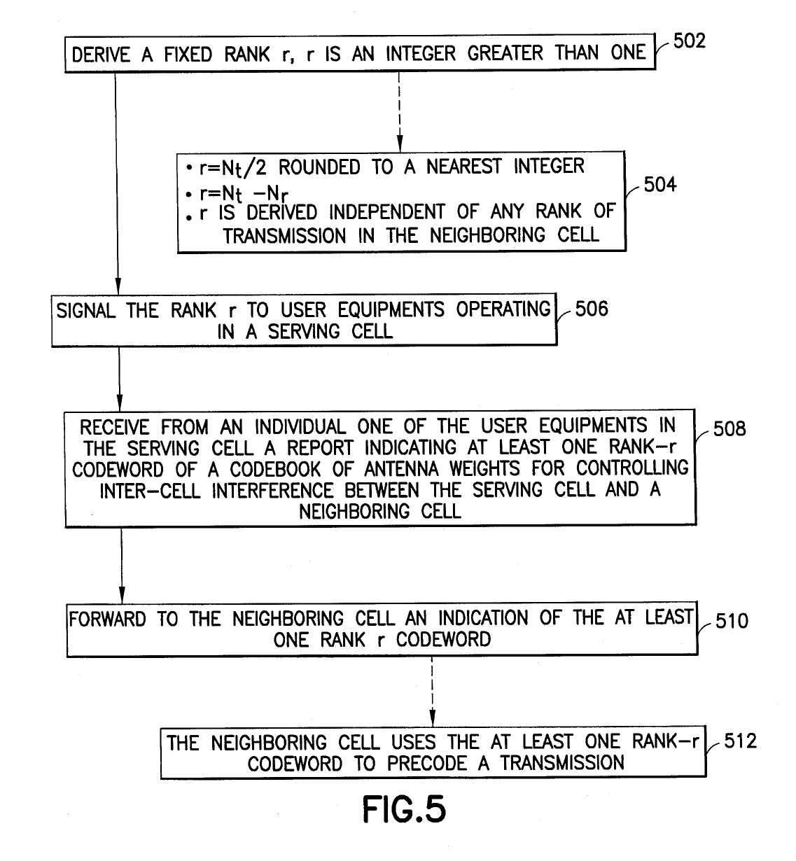

Now consider an exemplary embodiment of the invention from the perspective of the serving eNB 200. The serving cell/eNB 200 derives a fixed rank r which it sends to UEs in its cell (in which r is an integer greater than one), as shown at block 502 of FIG. 5. There are various ways in which the serving eNB 200 can derive the value for r, some of which are shown at block 504 of FIG. 5. The serving eNB 200 can estimate a number Nₜ of transmit antennas or ports that are active in the neighboring cell and select r as one half of the determined number Nₜ and rounded to a nearest integer. The serving eNB 200 can estimate a number Nₜ of transmit antennas that are active in the neighboring cell, estimate a number Nᵣ of receive antennas that are active in the serving cell; determine a difference between the number Nₜ and the number Nᵣ, and select r as the determined difference. Note that in either of these exemplary embodiments the value for r is derived independent of any rank of transmission in the neighboring cell 210, 220.

The serving eNB 200 signals the rank r to user equipments operating in the serving cell, shown at block 506 of FIG. 5 and for the one illustrated served UE 230 is shown as the signaling 202 of FIG. 2.

The serving eNB 200 then receives from an individual one of the UEs in the serving cell (the served UE 230 of FIG. 2) a report indicating at least one rank-r codeword of a codebook of antenna weights which would minimize or at least control inter-cell interference. In an embodiment, this means that if the neighbor cell 210 pre-coded its transmission with the codeword of rank-r that the served UE 230 reported to the serving cell 200, interference would be minimized (or at least controlled) between that transmission from the neighboring cell 210 and a transmission from the serving cell 200 to the served UE 230. This is shown in block 508 of FIG. 5 and as message 232 of FIG. 2. Message 232 may be termed the UE's PMI report.

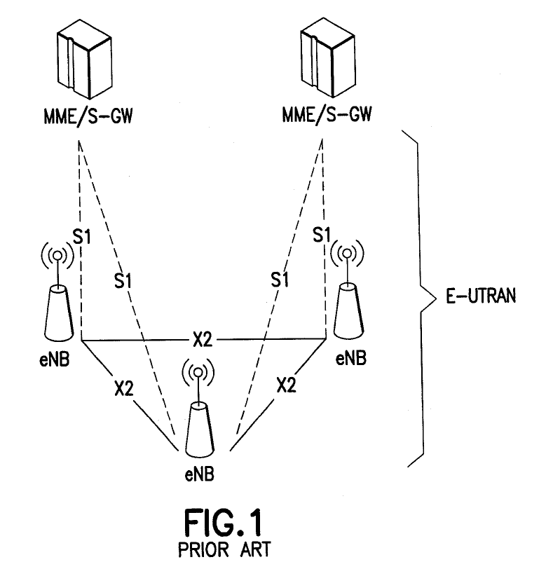

The serving eNB 200 distributes the selected codeword of rank-r, which it received from the served UE 230 in the PMI report 232, to the neighbor cell 210 via message 204. This may be done on the X2 interface of FIG. 1, for example, and is shown at block 510 of FIG. 5. If there are also reported codewords for other neighboring cells 220 the serving eNB 200 distributes them similarly. Having received from the serving eNB 200 the (at least one) rank-r codeword that was originally selected by the served UE 230, the neighboring eNB 210 selects at block 512 of FIG. 5 one of those reported rank-r codewords or rank-r PMI of the codebook, and uses it for its own transmissions in that neighboring cell. Note that the first neighboring cell 210 may get a rank-r codeword or rank-r PMI from the served cell 200 and from other adjacent cells, so it may have several to choose from for its transmissions. There are a few techniques detailed as to how this selection can be done. Note that the first neighboring cell 210 also reports to the serving eNB 200 (over an X2 interface by example) the one best PMI which the first neighboring cell UE 240 reported 242 to the first neighboring eNB 210, best being least interfering with the neighboring UE 240 if used by the serving cell 200. In a particular embodiment the first neighboring cell eNB 210 selects one of the rank-r codewords which are reported 242 by its own UE 242 to be identical to the single best codeword reported 232/204 by the served UE 230 as least interfering in the serving cell 200. For the case where the codebook has a nested property as noted above, selecting one of the rank-r codeword is done in an embodiment by the neighboring eNB 210 choosing a transmit precoding matrix indication (TPMI) being one column of any of the rank-r codewords or rank-r PMI indicated in the report 232/204 that originated from the served UE 230.

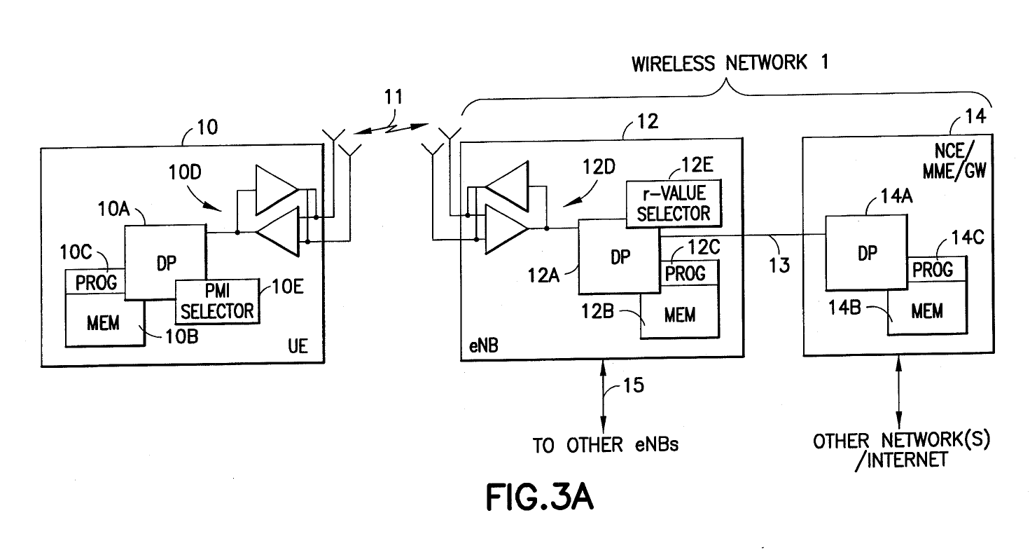

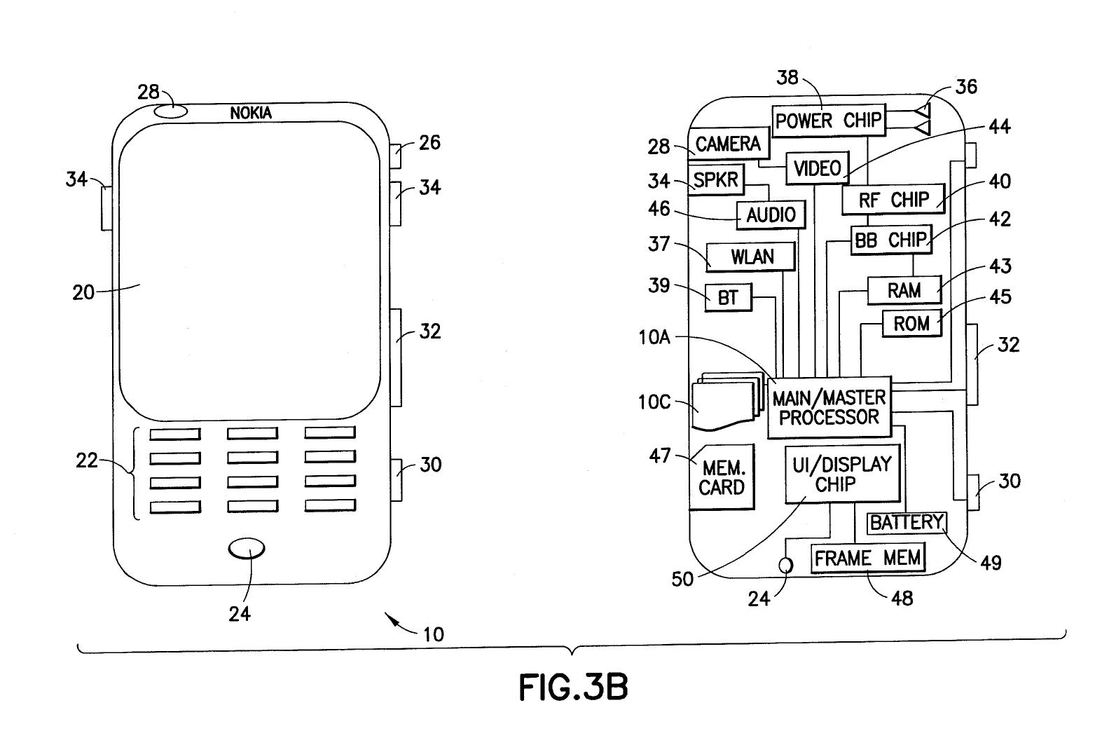

For completeness, reference is made to FIG. 3A for illustrating a simplified block diagram of various electronic devices and apparatus that are suitable for use in practicing the exemplary embodiments of this invention. In FIG. 3A a wireless network 1 which includes the serving cell is adapted for communication over a wireless link 11 with an apparatus, such as a mobile communication device which may be referred to as a UE 10/the served UE 230, via a network access node, such as a Node B (base station), and more specifically an eNB 12 such as the serving eNB 200. The network 1 may include a network control element (NCE) 14 that may include the MME/serving gateway (S-GW) functionality shown in FIG. 1, and which provides connectivity with a network 1, such as a telephone network and/or a data communications network (e.g., the Internet). The UE 10 includes a controller, such as a computer or a data processor (DP) 10A, a computer-readable memory medium embodied as a memory (MEM) 10B that stores a program of computer instructions (PROG) 100, and a suitable radio frequency (RF) transceiver 10D for bidirectional wireless communications with the eNB 12 via one or more antennas (two shown). The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas (two shown). The eNB 12 is coupled via a data/control path 13 to the NCE 14. The path 13 may be implemented as the S1 interface shown in FIG. 1. The eNB 12 may also be coupled to neighboring eNB(s) via data/control path 15, which may be implemented as the X2 interface shown in FIG. 1.

At least one of the PROGs 10C and 12C is assumed to include program instructions that, when executed by the associated DP, enable the device to operate in accordance with the exemplary embodiments of this invention such as those detailed above.

That is, the exemplary embodiments of this invention may be implemented at least in part by computer software executable by the DP 10A of the UE 10 and/or by the DP 12A of the eNB 12, or by hardware, or by a combination of software and hardware (and firmware).

For the purposes of describing the exemplary embodiments of this invention the UE 10 may be assumed to also include a PMI selector 10E which selects the set of best rank-r PMIs (those which exhibit minimal interference with other UEs scheduled in neighboring cell). The eNB 12 may be assumed to also include an r-value selector 12E which derives the value for r according by example to any of the techniques detailed above. In an exemplary embodiment the functions of blocks 10E and 12E are taken on by another processor or combination of hardware and software in the device rather than by a dedicated unit as FIG. 3A illustrates.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

FIG. 3B illustrates further detail of an exemplary UE in both plan view (left) and sectional view (right), and the invention may be embodied in one or some combination of those more function-specific components. At FIG. 3B the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user, there may be a camera 28 controlled by a shutter actuator 30 and optionally by a zoom actuator 32 which may alternatively function as a volume adjustment for the speaker(s) 34 when the camera 28 is not in an active mode. The camera 28 may be controlled by an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Within the sectional view of FIG. 3B are seen multiple transmit/receive antennas 36 that are typically used for cellular communication and relevant to the cooperative beamforming detailed above. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Certain embodiments of the UE 10 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various programs 10C are stored. All of these components within the UE 10 are normally powered by a portable power supply such as a battery 49.

The aforesaid processors 38, 40, 42, 44, 46, 50, if embodied as separate entities in a UE 10 or eNB 12, may operate in a slave relationship to the main processor 10A, 12A, which may then be in a master relationship to them. Embodiments of this may be disposed in one or across multiple ones of the various chips and memories as shown or disposed within another processor that combines some of the functions described above for FIG. 3B. Any or all of these various processors of FIG. 3B access one or more of the various memories, which may be on-chip with the processor or separate therefrom.

Similar function-specific components that are directed toward communications over a network broader than a piconet (e.g., components 36, 38, 40, 42-45 and 47) may also be disposed in exemplary embodiments of the access node 12/serving eNB 200, which may have an array of tower-mounted antennas rather than the two shown at FIG. 3A.

Note that the various chips (e.g., 38, 40, 42, etc.) that were described above may be combined into a fewer number than described and, in a most compact case, may all be embodied physically within a single chip.

The various blocks shown in FIGS. 4-5 may be viewed as method steps, and/or as operations that result from execution of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the LTE-A system, it should be appreciated that the exemplary embodiments of this invention are not limited for use with only this one particular type of wireless communication system, and that they may be used to advantage in other wireless communication systems such as for example (UTRAN, GSM, WCDMA, and other cellular communication systems).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (for example, PMI) are not intended to be limiting in any respect, as these parameters may be identified by any suitable names. Further, the various names assigned to different channels (for example PUCCH and PUSCH) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
determining from received signaling a fixed rank r, in which r is an integer greater than one;
selecting from a codebook of antenna weights at least one codeword of rank r for controlling inter-cell interference between a serving cell and a neighboring cell; and
reporting the selected at least one codeword of rank r to a serving cell.

2. The method according to claim 1, repeated for each of a plurality of N neighboring cells using respective rank rn, in which n=1, 2, . . . N and N is an integer greater than one, and in which each of the said codewords of rank rn is a codeword of a precoding matrix of antenna weights.

3. (canceled)

4. The method according to claim 1 in which selecting the at least one codeword of rank r comprises:
receiving from the neighboring cell a reference signal over a channel;
measuring the channel using the received reference signal;
attempting to precode using various codewords of the codebook of antenna weights; and
selecting the at least one codeword of rank r which would minimize power received in the serving cell of a transmission from the neighboring cell given the measured channel from the neighboring cell.

5-8. (canceled)

9. A memory storing a program of computer readable instructions that when executed by a processor result in actions comprising:
determining from received signaling a fixed rank r, in which r is an integer greater than one;
selecting from a codebook of antenna weights at least one codeword of rank r for controlling inter-cell interference between a serving cell and a neighboring cell; and
reporting the selected at least one codeword of rank r to a serving cell.

10-12. (canceled)

13. An apparatus, comprising:
at least one processor; and
at least one memory including computer program code;
the at least one memory and the computer program code configured to, with the at least one processor, cause the apparatus to perform:
determining from received signaling a fixed rank r, in which r is an integer greater than one;
selecting from a codebook of antenna weights at least one codeword of rank r for controlling inter-cell interference between a serving cell and a neighboring cell; and
reporting the selected at least one codeword of rank r to a serving cell.

14. The apparatus according to claim 13, in which the at least one memory and the computer program code are configured with the at least one processor to cause the apparatus to perform as recited in claim 13 repeated for each of a plurality of N neighboring cells using respective rank rn, in which n=1, 2, . . . N and N is an integer greater than one, and in which each of the said codewords of rank rn is a codeword of a precoding matrix of antenna weights.

15. The apparatus according to claim 14, in which the fixed rank r is received with a message that configures the apparatus to report the N neighboring cells.

16. The apparatus according to claim 13, in which the at least one memory and the computer program code are configured with the at least one processor to cause the apparatus to perform selecting the at least one codeword of rank r by performing:
receiving from the neighboring cell a reference signal over a channel;
measuring the channel using the received reference signal;
attempting to precode using various codewords of the codebook of antenna weights; and
selecting the at least one codeword of rank r which would minimize power received in the serving cell of a transmission from the neighboring cell given the measured channel from the neighboring cell.

17. The apparatus according to claim 13, in which the received signaling from which the fixed rank r is determined comprises broadcast system information.

18. The apparatus according to claim 13, in which the at least one memory and the computer program code are configured with the at least one processor to cause the apparatus to further perform:
sending to the serving cell a recommended value for r, prior to determining the fixed rank r.

19. The apparatus according to claim 13, in which the selected at least one codeword of rank-r is reported to the serving cell on one of a physical uplink control channel PUCCH and a physical uplink shared channel PUSCH.

20. The apparatus according to claim 13, in which the selected at least one codeword of rank r is reported to the serving cell with one of a channel quality indication and a rank indicator which indicates a number of spatial layers for data transmission.

21. A method comprising:
deriving a fixed rank r, in which r is an integer greater than one;
signaling the rank r to user equipments operating in a serving cell;
receiving from an individual one of the user equipments in the serving cell a report indicating at least one rank r codeword of a codebook of antenna weights for controlling inter-cell interference between the serving cell and a neighboring cell; and
forwarding to the neighboring cell an indication of the at least one rank r codeword.

22. The method according to claim 21, in which deriving the fixed rank r comprises estimating a number Nₜ of transmit antennas that are active in the neighboring cell and selecting r as one half of the determined number Nₜ and rounded to a nearest integer.

23. The method according to claim 21, in which deriving the fixed rank r comprises:
estimating a number Nₜ of user equipment transmit antennas that are active in the neighboring cell;
estimating a number Nᵣ of user equipment receive antennas that are active in the serving cell; and
determining a difference between the number Nₜ and the number Nᵣ; and
selecting r as the determined difference.

24-25. (canceled)

26. A memory storing a program of computer readable instructions that when executed by a processor result in actions comprising:
deriving a fixed rank r, in which r is an integer greater than one;
signaling the rank r to user equipments operating in a serving cell;
receiving from an individual one of the user equipments in the serving cell a report indicating at least one rank r codeword of a codebook of antenna weights for controlling inter-cell interference between the serving cell and a neighboring cell; and
forwarding to the neighboring cell an indication of the at least one rank r.

27-29. (canceled)

30. An apparatus, comprising:
at least one processor; and
at least one memory including computer program code;
the at least one memory and the computer program code configured to, with the at least one processor, cause the apparatus to perform:
deriving a fixed rank r, in which r is an integer greater than one;
signaling the rank r to user equipments operating in a serving cell;
receiving from an individual one of the user equipments in the serving cell a report indicating at least one rank r codeword of a codebook of antenna weights for controlling inter-cell interference between the serving cell and a neighboring cell; and
forwarding to the neighboring cell an indication of the at least one rank-r codeword.

31. The apparatus according to claim 30, in which deriving the fixed rank r comprises estimating a number Nₜ of transmit antennas that are active in the neighboring cell and selecting r as one half of the determined number Nₜ and rounded to a nearest integer

32. The apparatus according to claim 30, in which deriving the fixed rank r comprises:
estimating a number Nₜ of transmit antennas that are active in the neighboring cell;
estimating a number Nᵣ of receive antennas that are active in the serving cell; and
determining a difference between the number Nₜ and the number Nᵣ; and
selecting r as the determined difference rounded to a nearest integer.

33. The apparatus according to claim 30, in which the fixed rank r for the serving cell is derived independent of any rank of transmission in the neighboring cell.
